(19) United States
(12) Patent Application Publication
(10) Pub. No.: US 2004/0151429 A1
(43) Pub. Date: Aug. 5, 2004

(54) Integrated double pass equalizer for telecommunications networks

(76) Inventors: Siegfried Janz, Ottawa (CA); Dan-Xia Xu, Gloucester (CA); Pavel Cheben, Ottawa (CA); Andre Delage, Gloucester (CA); Lynden Erickson, Cumberland (CA); Boris Lamontagne, Ottawa (CA); Sylvain Charbonneau, Cumberland (CA)

Correspondence Address: MARKS & CLERK, P.O. BOX 957, STATION B, OTTAWA, ON, K1P 5S7, CA

(21) Appl. No.: 10/478,961

(22) PCT Filed: May 28, 2002
(86) PCT No.: PCT/CA02/00778

(30) Foreign Application Priority Data
May 28, 2001 (CA) 2349028

(51) Int. Cl. G02B 6/26

(52) U.S. Cl. 385/27; 385/140; 385/37

(57) ABSTRACT

Disclosed is an optical double pass equalizer for equalizing a wavelength division multiplexed (WDM) signal. The equalizer comprises a multiplexer/demultiplexer and multiple variable optical attenuators (VOAs) integrated on a single monolithic chip. The WDM signal is demultiplexed into individual wavelength channels by the multiplexer/demultiplexer and each wavelength channel is equalized by a corresponding VOA. The equalized wavelength channels are then multiplexed into an equalized WDM signal by the multiplexer/demultiplexer. This provides several advantages, including a reduction in required assembly and assembly cost, as well as an improved dynamic range in attenuation level or alternatively a reduction in power consumption for a fix attenuation level compared to a single pass VOA unit.

### FIELD OF THE INVENTION

This invention relates to the field of photonics, and more particularly to an integrated double pass equalizer for telecommunications networks, a method of equalizing WDM systems using an integrated double pass equalizer, as well as to an optical telecommunications network comprising at least one integrated double pass equalizer.

### BACKGROUND OF THE INVENTION

Accompanied with the recent advanced developments and intricacies in telecommunications technology (including voice, video and data signals), wavelength division multiplexed (WDM) transmission has been proposed as a way to transmit large amounts of information on optical fibres. WDM refers to sending a signal comprising multiple wavelength channels down a single fibre, in order to multiply the capacity of an individual fibre.

FIG. 1 shows a schematic diagram of an example of a WDM telecommunications network. One or more pairs of optical fibres are provided for upward and downward communication lines as transmission paths.

Optical transmitting terminal stations 10, 12 transmit a plurality of WDM channels, each of which has a different wavelength, along one of the optical fibres 18, 20, respectively. The transmitting terminal stations 10, 12 typically consist of a plurality of optical transmitters (not shown) (which may be semiconductor lasers), and an optical wavelength multiplexer (not shown) which combines all optical channels into a WDM signal before it is launched over the optical fibre 18, 20. Each transmitting station operates at a different wavelength and is modulated with a different data signal.

At the receiver terminal stations 14, 16, an optical wavelength demultiplexer (not shown) separates the light received over the fibre according to the wavelength. The signal transmitted on each wavelength is then detected by a respective optical receiver (not shown).

The WDM system reach, or the distance between the transmitting terminal stations 10, 12, and receiver terminal stations 14, 16, is limited by the attenuation or dispersion of the WDM signal along the optical fibre 18, 20, respectively. In an optical telecommunications network based on WDM, the net optical loss or gain between any two points in the system often varies from one wavelength channel to the next. The reach can be increased by placing optical amplifiers at intermediate points between the terminal stations. Examples of optical amplifiers are semiconductor optical amplifiers, and rare earth doped fibre amplifiers. Optical amplifiers simultaneously amplify all optical signals passing through it by amplifying the optical power by a gain.

Unfortunately, optical amplifiers exhibit a wavelength dependent gain profile, noise profile and saturation characteristics. Hence, each wavelength channel experiences a different gain along the transmission path. The amplifiers also add noise to the signal, typically in the form of amplified spontaneous emission, so that the optical signal-to-noise ratio decreases at each amplifier site. The optical signal-to-noise ratio is defined as the ratio of the signal power to the noise power in a reference optical bandwidth. This channel dependent loss or gain may arise from wavelength dependent amplifier gain or passive sources of wavelength dependent loss. Channel dependent loss or gain can be a serious problem, particularly when multiple sections with similar loss/gain are cascaded so that certain channels are successively amplified to unacceptably high levels while others get lost in the background noise. If possible, the source of the wavelength dependent loss or gain can be eliminated, for example by employing gain flattened erbium doped fibre amplifiers. Erbium doped fiber amplifiers have been developed to satisfy this need for single signal amplification. Such amplifiers consist of a length of optical waveguide fibre which has been doped with erbium. However, wavelength variations in loss or gain can never be entirely eliminated from the system. Therefore some form of spectral flattening must be used. As is well known in the art, the gain spectrum of an erbium doped fibre amplifier is flatter in the “red band” (the longer wavelength region from about 1540 to 1545 nm to about 1565 nm), than in the “blue band” (the shorter wavelength region from about 1525 nm to about 1535 to 1540 nm). In particular, a very flat gain in the red band can be achieved by adjusting the fraction of erbium ions in the excited “inverted” state through the selection of the length of the fibre amplifier and the level of pumping applied to the fibre. Known methods for implementing the spectral flattening work well for signal wavelengths in the red band.

Spectral flattening or channel equalization can be achieved by passive filters with a wavelength dependent transmission. Unfortunately, passive devices cannot adjust to dynamically changing conditions in the system. In an optical network, it is essential that each network element be able to transport a large number of optical signals that may have varying power levels. This is required because signal power levels dynamically change as signals are switched and routed through the network. Active channel equalization can be carried out using an equalizer 22 (shown schematically in FIG. 1) comprising a variable optical attenuator (VOA) in combination with a wavelength demultiplexer. An optical attenuator provides balance of optical power levels of data transmission, including balancing of signal-to-noise ratio and power leveling between different wavelengths in a WDM system. Usually, there is a large number of attenuators distributed throughout the system, the particular patterns dictated by the geometry of the network. The demultiplexer separates out each wavelength channel, and a separate VOA is used to attenuate each signal by a factor such that the final output intensities of all channels are the same. After the VOA, a multiplexer must be used in order to recombine all the channels back into a single optical signal. A number of schemes exist for achieving active channel equalization, all of which rely on the assembly of discrete demultiplexers, VOAs and multiplexers. Another prerequisite for any such system is the use of a channel monitor. The channel monitor measures the intensity of every channel and provides the necessary feedback to the VOA to ensure that all channel intensities are attenuated correctly.

FIG. 2 illustrates a simple 16-channel equalizer 22 in block diagram form. The equalizer 22 requires a demultiplexer 23, multiplexer 25, and sixteen VOAs 16, and will involve at least 66 separate fibre junctions. As a result, assembly will be the most important factor driving the package cost up, and assembly and packaging defects will be the most important factor in decreasing manufacturing yield. VOA devices generally require a certain power input in order to operate, particularly those based on thermo-optic and carrier injection effects. For WDM systems with many channels, each wavelength channel must have its own independent VOA. The result is that the system power consumption and dissipation can become quite large. This can be a problem both in terms of the cost and equipment required to supply that power, and in the removal of the dissipated heat at both the individual component and rack level.

WDM networks are widely spread and the custom demand for these networks is growing fast. They provide faster bit rates, and are more flexible in terms of the bandwidth per channel and complexity than the pervious single channel systems.

Therefore, what is, needed is a channel equalizer and an equalization procedure that is simple and reliable that will greatly simplify the operation, decreasing the packaging costs, and reduce the maintenance costs of WDM networks.

### SUMMARY OF THE INVENTION

An optical equalizer comprising an optical planar waveguide multiplexer/demultiplexer, waveguide mirrors and waveguide variable optical attenuators (VOAs) integrated on a single monolithic chip is disclosed.

In a broad aspect, the invention uses a double pass configuration for a channel equalizer based on an integrated variable optical attenuator (VOA) and a demultiplexer. Specifically, in one aspect, the invention provides an integrated optical equalizer for equalizing a wavelength division multiplexed (WDM) signal, comprising individual wavelength channels, transmitted on an optical fibre. The optical equalizer comprises, on a single monolithic chip, a multiplexer/demultiplexer for demultiplexing the WDM signal into the individual wavelength channels and a variable optical attenuator (VOA) having a plurality of channels corresponding to each demultiplexed wavelength channel. A reflective element returns each equalized channel to the multiplexer/demultiplexer so that the channels are multiplexed into an equalized WDM signal by the multiplexer/demultiplexer.

In another aspect, the invention provides a method of equalizing a wavelength division multiplexed (WDM) signal, comprising individual wavelength channels, transmitted on an optical fibre. The method comprises the steps of inputting the WDM signal into an integrated double pass optical equalizer comprising a multiplexer/demultiplexer and variable optical attenuator on a single monolithic-chip, demultiplexing the WDM signal into the individual wavelength channels with the multiplexer/demultiplexer, equalizing each individual wavelength channel with each variable optical attenuator corresponding to each wavelength channel, reflecting each individual wavelength channel from each VOA to the multiplexer/demultiplexer with a mirror corresponding to each VOA, multiplexing the equalized individual wavelength channels into an equalized WDM signal with the multiplexer/demultiplexer, and outputting the equalized WDM signal to the optical fibre.

Further disclosed is a method of fabricating an integrated optical equalizer. The method comprises the steps of preparing a substrate and fabricating a multiplexer/demultiplexer and multiple variable optical attenuators on the substrate by reactive ion etching in a single etching step.

Also disclosed is an optical transmission network comprising an integrated double pass optical equalizer.

The resulting integrated device requires only one input and output per fibre. This invention can be used as a channel equalizer in WDM systems.

### BRIEF DESCRIPTION OF THE DRAWINGS

The invention will now be described in more detail, by way of example, only with reference to the accompanying drawings, in which:

FIG. 1 illustrates an example of an optical network;

FIG. 2 is a block diagram of a channel equalizer block;

FIGS. 3a and 3b illustrate an equalizer comprising a double pass multiplexer/demultiplexer according to one aspect of the invention;

FIG. 4 illustrates the operation of an optical circulator; and

FIGS. 5a to 5f are schematic views illustrating the steps of one possible method of fabricating the equalizer of FIGS. 3a and 3b.

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

### DETAILED DESCRIPTION OF THE PREFERRED EMBODIMENTS

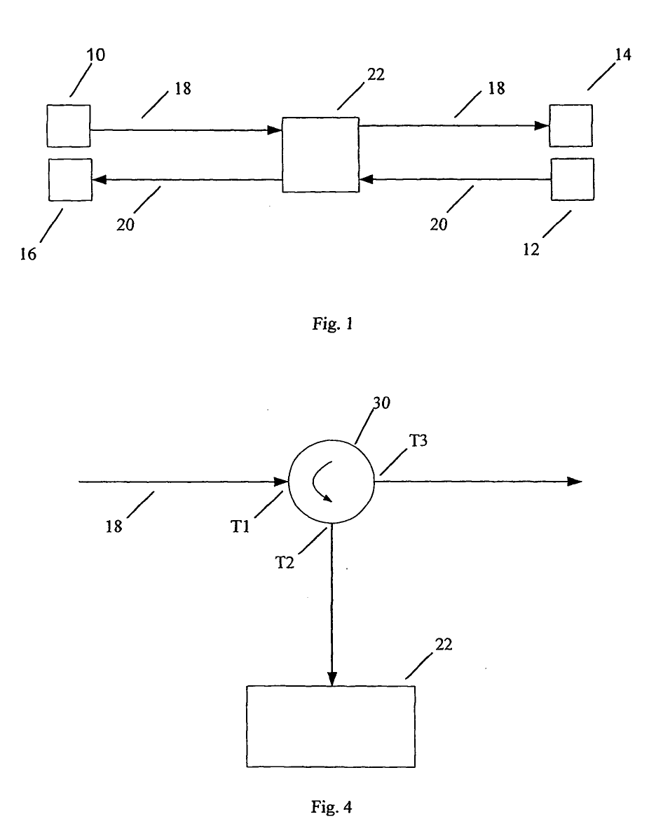

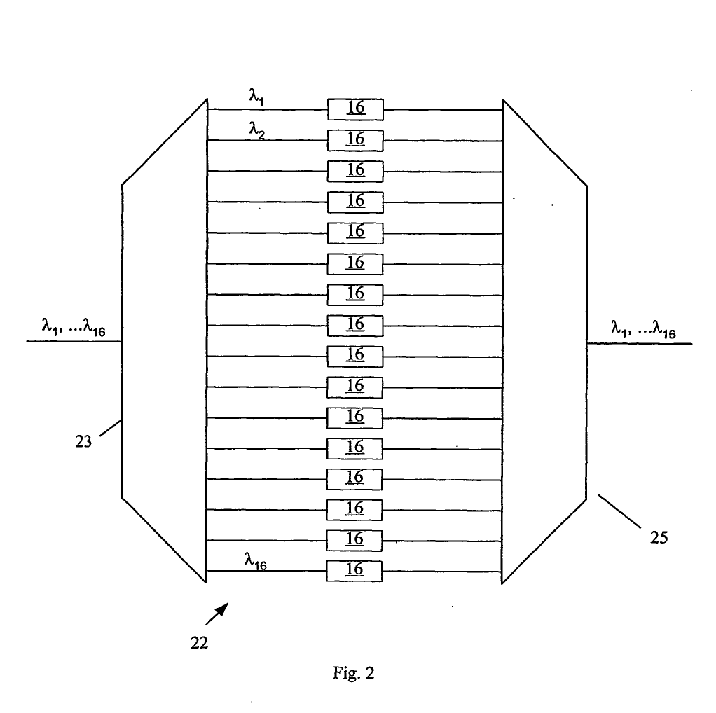

The WDM transmission system of FIG. 1 is constructed such that each optical fibre 18, 20 has a single direction optical transmission means connecting transmitting terminal stations 10, 12, and receiver terminal stations 14, 16 to transmit and receive WDM signals. For the sake of simplicity, only signals transmitted in one direction (optical fibre 18) are considered. One normally skilled in the art will understand the operation of a bidirectional network. Also for simplicity, the invention is described in terms of a receiver and transmitter, whereas a pair of transceivers could optionally be used.

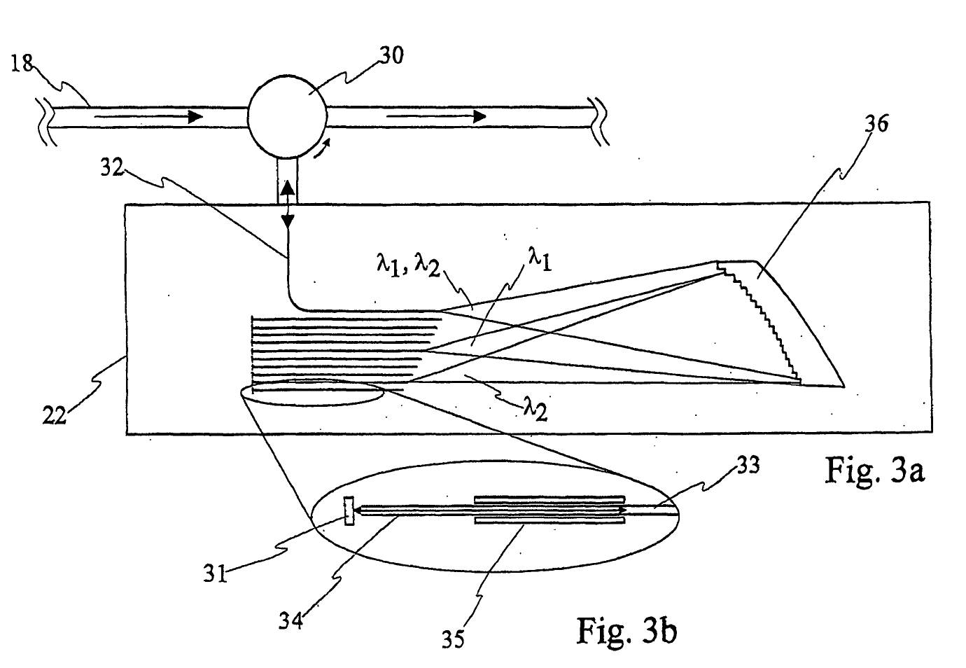

Referring to FIGS. 3 and 3b, there is shown a double pass configuration for a channel equalizer 22 based on integrated VOAs and multiplexer/demultiplexer in accordance with the principles of the invention. The equalizer 22 is a single monolithic chip positioned between optical transmitting terminal station 10 and receiver terminal station 16, as seen in FIG. 1. The equalizer 22 draws wavelength channels, λₙ, from the WDM signal transmitted by the transmitting terminal station 10, propagating through the signal direction optical fibre 18, and equalizes the channels before sending them to receiver terminal station 14.

In order to accomplish the forgoing, an optical signal consisting of many different wavelength channels, λ₁, λ₂, is directed from the optical fibre 18 to the chip 22 by a switching circuit 30. The switching circuit 30, shown in FIG. 4 as an optical circulator 30, has three terminals T1, T2, T3, and transmits WDM signals input from one terminal to an adjacent terminal in a direction shown by the arrow. The optical circulator 30 could have a different number of terminals. The terminal T1 is connected to the input of optical fibre 18, the terminal T2 is connected to the terminal of equalizer 22, and the terminal T3 is connected to the output of optical fibre 18. When the optical signal is input from the optical fibre 18 via terminal T1, the circulator 30 guides the optical signal in the direction shown by the arrow and outputs the optical signal via terminal T2 to the equalizer 22. That is, terminal T2 is adjacent terminal to terminal T1.

The optical signal is coupled from the fibre 18 through the input waveguide 32 to echelle grating 36. The echelle grating 36 acts as a demultiplexer and separates out the wavelength channels from the WDM signal. The separated wavelength channels are directed into corresponding output waveguides 33, and pass through the VOA sections 35 and out to waveguides 34. The VOAs are used to attenuate optical channels by adjustable attenuation factors. For example, an optical channel having a level of −5 dBm may be attenuated by 5 dB to produce an output channel having a level of −10 dBm. The VOAs provide varying attenuation to each wavelength channel so that their respective powers are balanced, and thus experience similar losses, when transmitted along optical fibre 18 toward receiver terminal station 14.

Finally, the light exits the VOAs 35 and strikes a corresponding mirror 31 that reflects the light back through the VOAs 35 and to echelle grating 36. Since the beam paths of the optical signal are precisely reversed when it strikes each mirror (double pass), the echelle grating now acts as a multiplexer and all channels are recombined into a single WDM signal. The recombined signal is passed onto the input waveguide 32 and input to optical circulator 30 via terminal T2. The optical circulator 30 then directs the attenuated channels to optical fibre 18 via terminal T3 and downstream from the signal source.

The forgoing specific description has related exclusively to an equalizer employing optical waveguide gratings, but it should be clearly understood that the invention is not limited exclusively to the use of this particular type of optical grating, but is applicable to equalizers employing optical diffraction in general. The multiplexer/demultiplexer 36 is preferably waveguide based. Either an echelle grating based device, or an arrayed waveguide grating (AWG) device can be used. The echelle grating is preferred since its footprint is much smaller than that for an AWG. For a discussion on each technology, see the White Paper prepared by the Applicant entitled “Silicon-based Echelle Grating Technology Metropolitan and Long-Haul DWDM Applications”, 2001, which is incorporated herein by reference.

The waveguide VOA can be based on a number of mechanisms. There are a variety of types of optical attenuators developed up to date,. As an example, they include waveguides with electronically variable properties and micromechanical structures brought by the rapid advances of the microelectromechanical (MEM) technology.

The waveguide based multiplexer/demultiplexer 36 and waveguide VOAs 35 are preferably fabricated in silicon-on-insulator (SOI) wafers by deep reactive ion etching which allows the fabrication of the multiplexer/demultiplexer 36 and VOAs 35 using a two-etch process, one for etching the waveguide and one for etching the gratings.

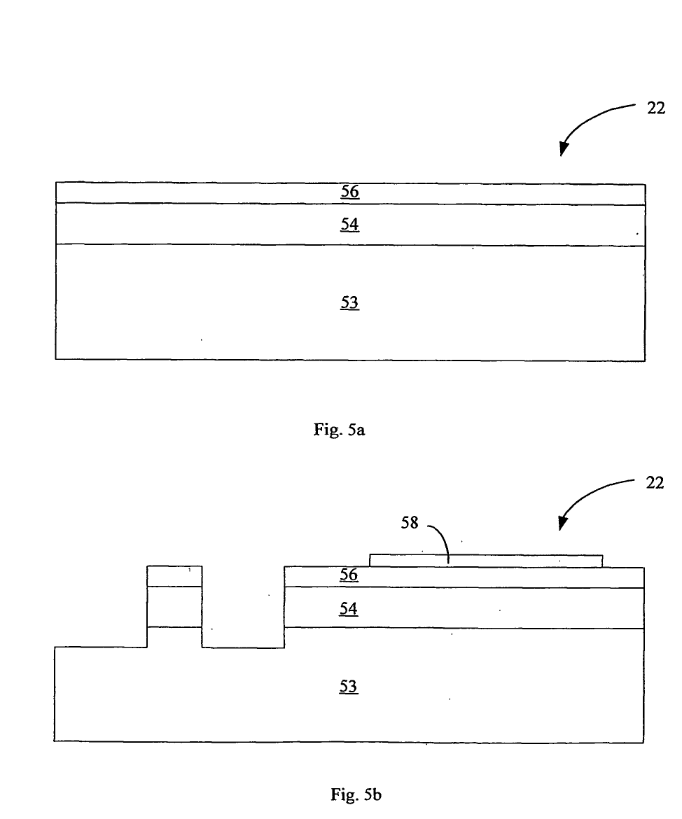

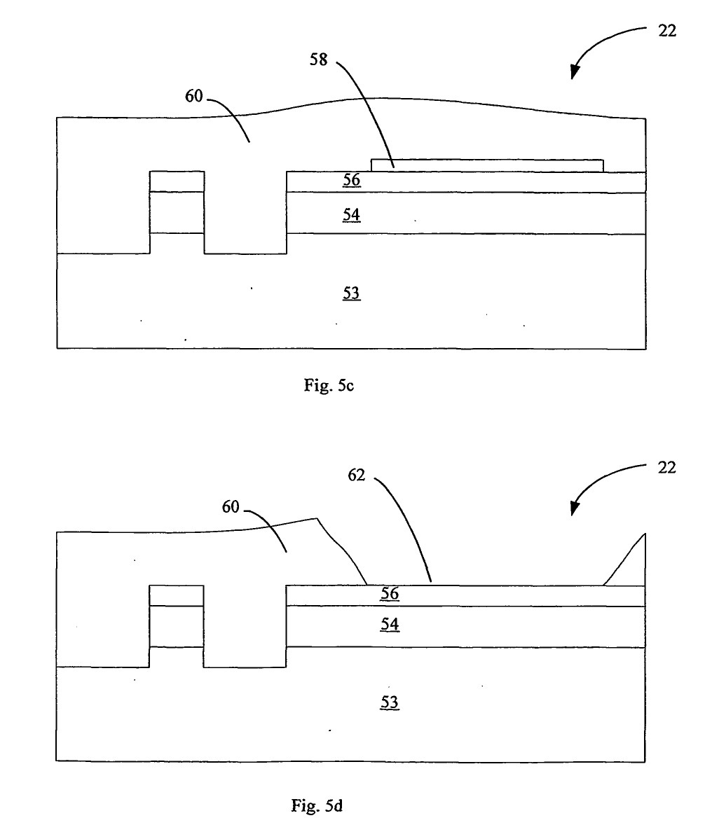

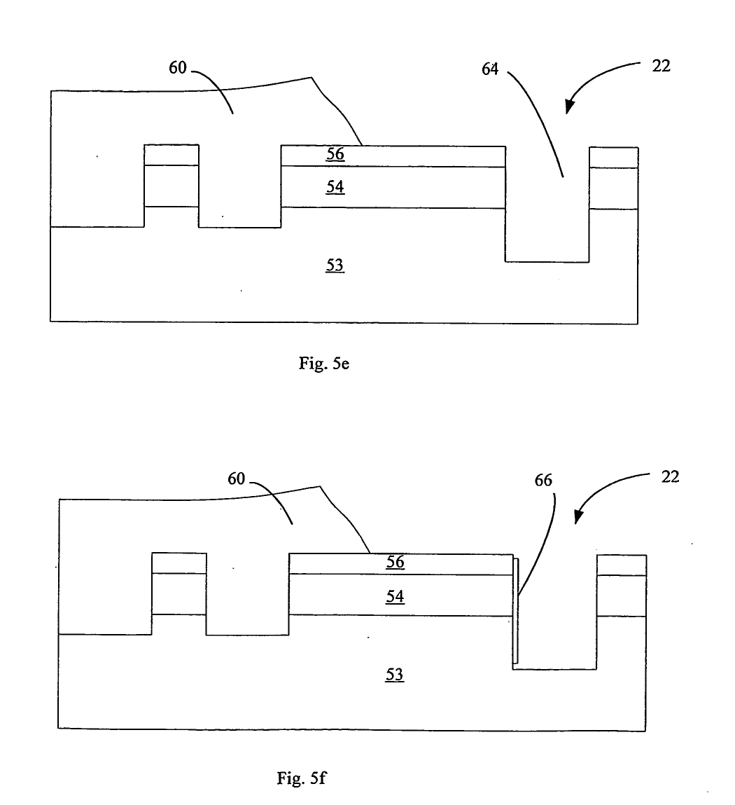

FIGS. 5a to 5f illustrate one possible two-etch process that may be used to fabricate the equalizer 22. The process described hereinafter is an example only and is not intended to be limiting in any way. FIGS. 5a to 5f are not drawn to scale and are presented in their current form for illustrative purposes. In his particular example, first the core 54 and cladding 56 are deposited on the buffer 53, as seen in FIG. 5a. The cladding thickness may be approximately 0.5 μm. The core layer 54 may be made of single crystal silicon layer or any other suitable material, such as silicon, silicon oxynitride, silicon nitride and III-V semiconductors. Typically, the buffer 53 is made of a silicon oxide layer, and a silicon oxide layer formed by oxidizing the surface of the core layer 54 is based as the cladding layer 56.

Then the waveguide is patterned and etched, as seen in FIG. 5b. The etching is preferably a deep vertical etch, about 6 μm deep, but any suitable etching process may be used. Then an Etch Assist Layer 58 (EAL) is deposited on a portion of the cladding 56. The EAL 58 may be silicon nitride, aluminum or any other suitable material.

Referring to 5c, a second layer of cladding 60 is deposited over the entire area. In FIG. 5d, the compensation 62 is patterned and the cladding 60 and EAL 58 are etched. As seen in FIG. 5e, the gratings 64 are patterned and etched. Preferably, this is performed with a hard mask. Thereafter, the hard mask is removed and the top surface cleaned. Referring to FIG. 5f, a layer of silicon nitride may be deposited by any suitable means, such as plasma-enhanced vapor deposition (PECVD), with a thickness, for example, of about 100 μm, and the gratings are metalized at 66, preferably with gold or aluminum.

Thus the attenuator is formed as a monolithic structure. For example, if a silicon-on-insulator (SOI) or other semiconductor waveguide platform is used for the chip, a carrier injection using electro-optic effect or an electrostatically activated MEMS VOA can be used. In the case of glass and/or polymer waveguide chip, the VOA will likely be a thermo-optic device. If required, the VOA devices may be arranged into an array according to a predetermined pattern. Depending on the system requirements, it is also possible to arrange VOA devices into a matrix or any other two-dimensional array having the necessary geometry.

The waveguide mirrors 31 require vertical etches to within one degree or less in the material system used. High reflectivity can be achieved using metal or multilayer dielectric coatings. In the case of high refractive index waveguides such as (silicon-on-insulator) SOI, silicon oxynitride or InGaAsP, high reflectivity can be achieved by terminating the waveguides with right angle corner reflectors. Total internal reflection at the waveguide/air interface should in theory give 100% reflectivity. In particular, a critical issue for etched grating demultiplexers is the verticality and smoothness of the deeply etched grating facets. In silica-based materials, the technique used to fabricate the waveguides and grating is reactive ion etching. Using this technique, grating wall verticality better than 89.8° with a RMS roughness better than 30 nm over 30 microns can be achieved on a production tool. The reliability and reproducibility of the fabrication process for vertical facets in silica-based planar waveguide eliminates the main disadvantage of echelle grating demultiplexers. The use of SOI wafers allow also to obtain a uniform etching depth i.e. the plasma etching stops when the buried oxide is reached. Other known patterning techniques, for example photolithographic patterning, plasma etching, wet etching, material deposition techniques, also may be used to pattern the device.

Using the optical circulator 30, the waveguide multiplexer/demultiplexer 36, and waveguide VOAs 35, the double pass equalizer 22 can equalize a WDM signal in a telecommunications network. An advantage of this equalizer is the reduction of required assembly. There is only one fibre to waveguide junction required, for any number of channels. This leads to an enormous reduction in assembled device cost. A separate optical circulator is required to separate the up and downstream paths, but connectorized circulators are readily available with very good performance at a small relative cost.

There is also a reduction in package footprint. Since there is no internal fibre to waveguide coupling and no internal fibre lengths, the size of the packaged device is much smaller than a similar channel equalizer composed of discrete components.

As well, there is a reduction in VOA power or voltage requirements. Since each channel passes through the VOA twice, the power (or voltage in the case of electro-optic or electrostatic MEM VOAs) required to achieve a given attenuation is half that required in conventional demultiplexer VOA assemblies.

Numerous modifications may be made without departing from the spirit and scope of the invention as defined in the appended claims.

What is claimed is:

1. An optical equalizer comprising an integrated variable optical attenuator and demultiplexer in a double pass configuration.

2. An optical equalizer as claimed in claim 1, further comprising a mirror for returning incident light back through said variable optical attenuator and demultiplexer.

3. An integrated optical equalizer for equalizing a wavelength division multiplexed (WDM) signal transmitted on an optical fibre, the WDM signal comprising individual wavelength channels, the optical equalizer comprising, on a single monolithic chip:
a multiplexer/demultiplexer for demultiplexing the WDM signal into the individual wavelength channels;
a variable optical attenuator (VOA) corresponding to each wavelength channel for equalizing each demultiplexed wavelength channel;
a reflective element for returning each equalized channel to the multiplexer/demultiplexer so that the channels are multiplexed into an equalized WDM signal by the multiplexer/demultiplexer.

4. The optical equalizer as claimed in claim 3, wherein the reflective element is a mirror corresponding to each VOA for reflecting each equalized wavelength channel to the multiplexer/demultiplexer for multiplexing.

5. The optical equalizer as claimed in claim 4, further comprising a switching unit for inputting and outputting the WDM signal from and to the optical fibre.

6. The optical equalizer as claimed in claim 5, wherein the switching unit is an optical circulator comprising:
a first terminal for receiving the WDM signal from the optical fibre;
a second terminal for inputting and outputting the WDM signal to and from the multiplexer/demultiplexer; and
a third terminal for outputting the WDM signal to the optical fibre.

7. The optical equalizer as claimed in claim 5, further comprising:
an input waveguide for guiding the WDM signal between the switching circuit and the multiplexer/demultiplexer; and
output waveguides for guiding the wavelength channels between each VOA and the multiplexer/demultiplexer.

8. The optical equalizer of claim 3, wherein the multiplexer/demultiplexer is an echelle grating.

9. The optical equalizer of claim 3, wherein the multiplexer/demultiplexer is an arrayed waveguide grating.

10. The optical equalizer of claim 3, wherein each VOA is based on microelectromechanical technology (MEMS).

11. The optical equalizer of claim 3, wherein each VOA is based on carrier injection using electro-optic effects.

12. The optional equalizer of claim 3, wherein each VOA is based on thermo-optic effects.

13. A method of equalizing individual wavelength channels of a wavelength division multiplexed (WDM) signal transmitted on an optical fibre, the WDM signal comprising individual wavelength channels, the method comprising the steps of:
inputting the WDM signal into an integrated double pass optical equalizer comprising a multiplexer/demultiplexer and variable optical attenuators on a single monolithic chip;
demultiplexing the WDM signal into the individual wavelength- channels with the multiplexer/demultiplexer;
equalizing each individual wavelength channel with each variable optical attenuator corresponding to each wavelength channel;
reflecting each individual wavelength channel from each VOA to the multiplexer/demultiplexer with a mirror corresponding to each VOA;
multiplexing the equalized individual wavelength channels into an equalized WDM signal with the multiplexer/demultiplexer; and
outputting the equalized WDM signal to the optical fibre.

14. An optical transmission network comprising:
an optical fibre installed between a transmitting terminal station and a receiver terminal station; and
an integrated double pass optical equalizer comprising a multiplexer/demultiplexer and variable optical attenuator on a single monolithic chip, positioned between the transmitting terminal station and a receiver terminal station.

15. The optical transmission network of claim 14, further comprising a plurality of optical fibres, each being installed between a corresponding transmitting, terminal station and a corresponding receiver terminal station; and
an integrated double pass optical equalizer positioned between each pair of transmitting, terminal station and a receiver terminal station.

16. A method of fabricating an integrated optical equalizer, the method comprising the steps of:
preparing a substrate having a top surface; and
fabricating a multiplexer/demultiplexer and multiple variable optical attenuators on the substrate by reactive ion etching in a two-etch process.
